(19) United States
(12) Patent Application Publication
(10) Pub. No.: US 2006/0262061 A1
(43) Pub. Date: Nov. 23, 2006

(54) Liquid crystal display device with common electrode having a plurality of openings

(75) Inventors: Yun Szu Liu, Miao-Li (TW); Tsau Hua Hsieh, Miao-Li (TW); Hung Yu Chen, Miao-Li (TW); Chao Chih Lai, Miao-Li (TW); Chao I. Hung, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/439,463

(22) Filed: May 23, 2006

(30) Foreign Application Priority Data
May 23, 2005 (TW) 94208354

(51) Int. Cl. G09G 3/36

(52) U.S. Cl. 345/92

(57) ABSTRACT

A liquid crystal display device (100 or 200) includes a first substrate (110 or 210) and a second substrate (120 or 220) opposite to each other, a liquid crystal layer (130 or 230) sandwiched between the first and second substrates; a common electrode (140 or 240) formed on the first substrate, and the common electrode having a plurality of openings (180 or 280); and a plurality of gate lines (150 or 250) formed on the second substrate and positionally corresponding the openings respectively. Moreover, the gate lines can be arranged with the areas of the second substrate corresponding to the openings. The coupled capacitor delaying of signals of gate electrodes in the TFTs can be reduced. Accordingly, flickering can be reduced, and the display performance can be improved.

### FIELD OF THE INVENTION

The present invention relates to liquid crystal display (LCD) devices, and particularly relates to an LCD device with a common electrode having a plurality of openings.

### BACKGROUND

An active matrix LCD generally includes a plurality of pixel regions defined by a plurality of gate lines and a plurality of data lines that cross each other. A plurality of thin film transistors (TFTs) are respectively arranged at a plurality of intersections of the gate lines and data lines. Each pixel region includes a pixel electrode, which is controlled by a corresponding TFT.

Referring to FIG. 6, this shows a typical liquid crystal display device. The liquid crystal display device 10 includes a first substrate 11 and a second substrate 12 opposite to each other, and a liquid crystal layer 13 comprising a plurality of liquid crystal molecules sandwiched between the first and second substrates 11, 12. A common electrode 14 is formed on an inside of the first substrate 11, and has a flat surface. A plurality of gate lines 15 are provided on the second substrate 12 to drive a plurality of TFTs 20 (see FIG. 7). An alignment film 17 is provided on the gate lines 15 to control alignment directions of the liquid crystal molecules. A plurality of spacers 16 are provided between the first and second substrates 11, 12, to support and separate the first and second substrates 11, 12.

Referring to FIG. 7, this shows an operating principle of one TFT 20 of the liquid crystal display device 10. The TFT 20 includes a gate electrode 21, a source electrode 22, and a drain electrode 23. When the liquid crystal display device 10 is on, a voltage A is applied to the gate electrode 21 through the corresponding gate line 15. If the voltage A is higher than a threshold voltage of the TFT 20, the TFT 20 is switched on, and a voltage B is transmitted to a pixel electrode 27 through a corresponding data line 26, the source electrode 22 and the drain electrode 23 to control rotation of the liquid crystal molecules. If the voltage A is lower than the threshold voltage of the TFT 20, the TFT 20 is switched off; thus the voltage B cannot be transmitted to the pixel electrode 27, and the liquid crystal molecules cannot rotate.

As shown in FIG. 6, some portions of the common electrode 14 cover the gate lines 15 or other electrical conductors. Therefore, as shown in FIG. 7, a plurality of coupled capacitors 28 are cooperatively formed by the gate lines 15 and the plurality of portions of the common electrode 14 covering the gate lines 15. Thus when the voltage A is applied to the gate electrode 21, the voltage A is first applied to the corresponding coupled capacitor 28. That is, the application of the voltage A to the gate electrode 21 is delayed. Accordingly, a display screen of the liquid crystal display device 10 is liable to flicker.

What is needed, therefore, is a liquid crystal display device which can reduce flicker and provide good display performance.

### SUMMARY

A liquid crystal display device includes: a first substrate and a second substrate opposite to each other; a liquid crystal layer sandwiched between the first and second substrates; a common electrode formed on the first substrate, the common electrode having a plurality of openings; and a plurality of gate lines formed on the second substrate and positionally corresponding the openings respectively.

Another liquid crystal display device includes a first base plate comprising a first substrate and a common electrode formed at the first substrate, the common electrode comprising a plurality of portions with spaces therebetween; a second base plate opposite to the first base plate, the second base plate comprising a second substrate and a plurality of gate lines formed at the second substrate and positionally corresponding the spaces of the first base plate respectively; and a liquid crystal layer sandwiched between the first and the second base plates

In the described-above liquid crystal display devices, the common electrode includes the openings or spaces, with the openings or spaces overlying the gate lines. In a conventional liquid crystal display device, the common electrode has some portions covering the gate lines respectively. Therefore, compared with the conventional liquid crystal display device, the overlapping portions of the gate lines and the common electrode are reduced. Thus, the amount and or strength of coupled capacitors formed between the gate lines and the common electrode is reduced. Accordingly, in the described-above liquid crystal display device, flickering can be reduced, and a better display performance can be obtained.

In a preferred embodiment, the width of the gate lines is equal to or less than that of the openings respectively. That is, there is no direct overlapping between any portions of the gate lines and the common electrode. Therefore, the gate lines and the common electrode do not form any coupled capacitors. Thus, delaying of the signal of the gate electrode in the TFT by the coupled capacitor can be reduced. Accordingly, flickering can be reduced, and the display performance of the liquid crystal display device can be improved.

Other advantages and novel features will become more apparent from the following detailed description when taken in conjunction with the accompanying drawings, in which:

### BRIEF DESCRIPTION OF THE DRAWINGS

FIG. 1 is a schematic, side cross-sectional view of part of a liquid crystal display device according to a first preferred embodiment of the present invention;

FIG. 2 is a schematic, top plan view of a common electrode of the liquid crystal display device shown in FIG. 1;

FIG. 3 is a schematic, top plan view of an alternative embodiment of a common electrode, which can be used in the liquid crystal display device of FIG. 1;

FIG. 4 is a schematic, top plan view of another alternative embodiment of a common electrode, which can be used in the liquid crystal display device of FIG. 1;

FIG. 5 is a schematic, side cross-sectional view of part of a liquid crystal display device according to a second preferred embodiment of the present invention;

FIG. 6 is a schematic, side cross-sectional view of part of a conventional liquid crystal display device; and

FIG. 7 is a schematic diagram of one of TFTs and associated parts and circuitry of the liquid crystal display device of FIG. 6, showing an operating principle thereof.

### DETAILED DESCRIPTION OF PREFERRED EMBODIMENTS

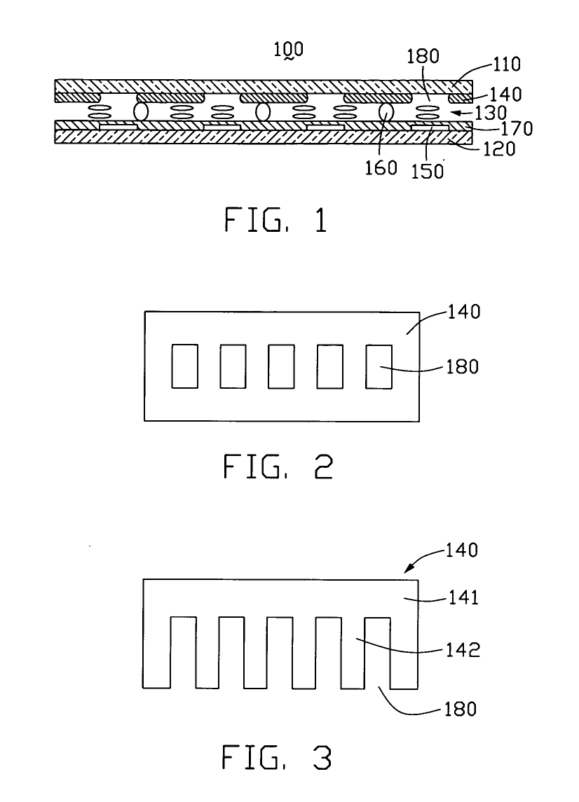

Referring to FIG. 1, this shows part of a liquid crystal display device according to a first preferred embodiment of the present invention. The liquid crystal display device 100 includes a transparent first substrate 110 and a transparent second substrate 120 opposite to each other, and a liquid crystal layer 130 including a plurality of liquid crystal molecules sandwiched between the first and second substrates 110, 120. A transparent conductive layer functioning as a common electrode 140 is formed on an inner surface of the first substrate 110. A plurality of gate lines 150 are formed on the second substrate 120, to drive and control a plurality of TFTs (not shown). An alignment film 170 is formed on the gate lines 150 and the second substrate 120, to control alignment directions of the liquid crystal molecules. A plurality of spacers 160 are provided between the first substrate 110 and the second substrate 120, to separate and support the first and second substrates 110, 120. The common electrode 140 includes a plurality of openings 180, and the openings 180 are located above the gate lines 150 respectively. Referring also to FIG. 2, the openings 180 may define a rectangular shape, as viewed from above. In particular, in the illustrated embodiment, the openings 180 are holes. A width of each of the gate lines 150 may be equal to, larger than, or less than a corresponding width of each of the openings 180, wherein the openings 180 partly or wholly overlie the corresponding gate lines 150. The common electrode 140 typically includes one or more solid portions that overlap corresponding one or more of the spacers 160. Furthermore, the one or more solid portions of the common electrode 140 may partially or fully overlap the corresponding one or more of the spacers 160.

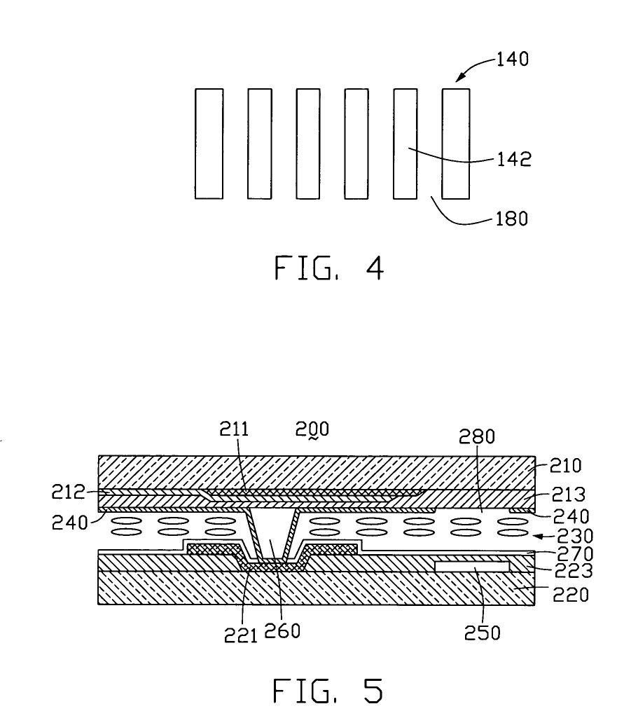

In an alternative embodiment, as shown in FIG. 3, each of the openings 180 may instead be a blind slot. In this configuration, the common electrode 140 includes a base portion 141, and a plurality of parallel branches 142 extending from a same long side of the base portion 141. Thus the branches 142 are interleavedly separated by the openings 180. In another alternative embodiment, as shown in FIG. 4, each of the openings 180 may instead be a through slot. In this configuration, the common electrode 140 comprises a plurality of parallel discrete, elongate portions 142 interleavedly separated by the openings 180.

In addition, a width of the openings 180 may be equal to, larger than, or less than a corresponding width of the gate lines 150. Further, the common electrode 140 may or may not include one or more solid portions that partially or even fully overlap one or more of the gate lines 150.

As described above, the common electrode 140 includes the openings 180, with the openings 180 overlying the gate lines 150. Therefore compared with the above-described conventional liquid crystal display device 10, in the liquid crystal display device 100, overlapping as between the common electrode 140 and the gate lines 150 is reduced or even eliminated. Thus the amount and/or strength of coupled capacitors formed between the gate lines 150 and the common electrode 140 is reduced. Accordingly, in the liquid crystal display device 100, flickering can be reduced, and a better display performance can be obtained.

Further, in a preferred embodiment, the gate lines 150 are entirely located within areas of the second substrate 120 that correspond to the areas of the openings 180. That is, there is no direct overlapping between any portions of the common electrode 140 and the gate lines 150. Therefore the gate lines 150 and the common electrode 140 essentially do not form any coupled capacitors. Thus coupled capacitor delaying of signals of gate electrodes in the TFTs can be reduced. Accordingly, flickering can be reduced, and the display performance of the liquid crystal display device 100 can be improved. In experimental verification of the preferred embodiment, because the gate lines 150 and the common electrode 140 essentially do not form any coupled capacitors, a capacitance of coupled capacitor delaying of the signal of the gate electrode in one TFT can be reduced about 20%.

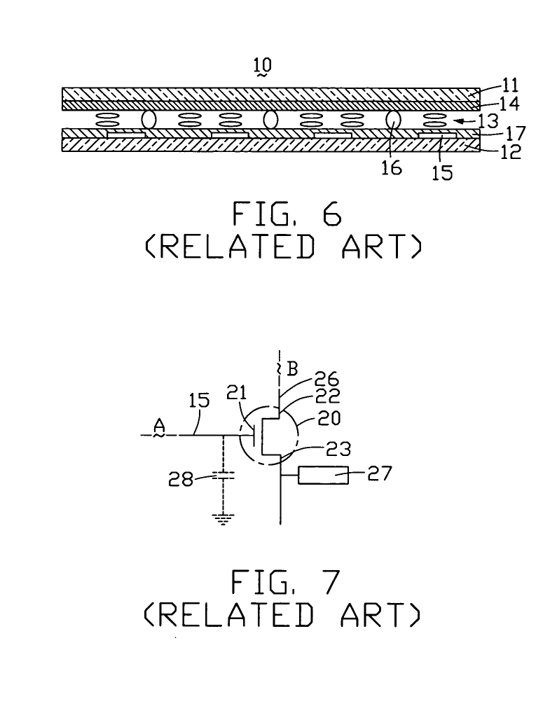

Referring to FIG. 5, this shows a liquid crystal display device according to a second preferred embodiment of the present invention. The liquid crystal display device 200 includes a transparent first substrate 210 and a transparent second substrate 220 opposite to each other, and a liquid crystal layer 230 sandwiched between the first and second substrates 210, 220. A black matrix 211, a color filter 212, and a passivation layer 213 are formed on an inner surface of the first substrate 210, in that order from top to bottom. A plurality of spacers 260 are provided between the first substrate 210 and the second substrate 220, to separate and support the first and second substrates 210, 220. A transparent conductive layer functioning as a common electrode 240 is formed on the passivation layer 213. A plurality of gate lines 250 are formed on the second substrate 220 to drive and control a plurality of TFTs (not shown). A passivation layer 223 is formed on the second substrate 220 and the gate lines 250. A plurality of common lines 221 are formed on the second substrate 220 and adjacent portions of the passivation layer 223. An alignment film 270 is formed on the common lines 221 and the passivation layer 223.

In this embodiment, the common electrode 240 includes a plurality of openings 280, and the openings 280 overlie the gate lines 250. The common electrode 240 includes at least one portion covering bottom and side portions of a corresponding spacer 260, as shown. The portion of the common electrode 240 covering the spacer 260 penetrates a corresponding portion of the alignment film 270 to electrically connect with a corresponding common line 221. The openings 280 of the common electrode 240 can have configurations similar to those described above in relation to the openings 180 of the liquid crystal display device 100 of the first embodiment. In particular, the openings 280 can be holes, blind slots, or through slots. In alternative embodiments, portions of the common electrode 240, the passivation layer 213, and/or the first substrate 210 can be configured to accommodate one or more of the spacers 260.

As described above, the common electrode 240 includes the openings 280, with the openings 280 overlying the gate lines 250. Therefore compared with the above-described conventional liquid crystal display device 10, in the liquid crystal display device 200, overlapping as between the common electrode 240 and the gate lines 250 is reduced or even eliminated. Thus the amount and/or strength of coupled capacitors formed between the gate lines 250 and the common electrode 240 is reduced. Accordingly, in the liquid crystal display device 200, flickering can be reduced, and a better display performance can be obtained.

In various embodiments, the substrates 110, 120, 210, 220 may be made of glass or silicon oxide. The common electrodes 140, 240 may be made of indium tin oxide (ITO) or indium zinc oxide (IZO). The substrates 110, 120, 210, 220 and any of the elements formed thereon may be in the form of a plate, a film, and so on.

It is to be further understood that even though numerous characteristics and advantages of various embodiments have been set forth in the foregoing description, together with details of the structures and functions of the embodiments, the disclosure is illustrative only, and changes may be made in detail to the full extent indicated by the broad general meaning of the terms in which the appended claims are expressed.

What is claimed is:

1. A liquid crystal display device, comprising:
a first substrate and a second substrate opposite to each other;
a liquid crystal layer sandwiched between the first and second substrates;
a common electrode formed on the first substrate, the common electrode having a plurality of openings; and
a plurality of gate lines formed on the second substrate and positionally corresponding the openings respectively.

2. The liquid crystal display device as recited in claim 1, wherein a width of each of the gate lines is equal to or less than a corresponding width of each of the openings.

3. The liquid crystal display device as recited in claim 1, wherein at least one of the gate lines underlies one or more of the openings.

4. The liquid crystal display device as recited in claim 1, further comprising a plurality of spacers between the first and second substrates.

5. The liquid crystal display device as recited in claim 4, wherein the common electrode comprises at least one solid portion partially or fully overlapping a corresponding one of the spacers.

6. The liquid crystal display device as recited in claim 4, wherein the common electrode comprises at least one solid portion partially or fully covering bottom and side portions of a corresponding one of the spacers.

7. The liquid crystal display device as recited in claim 6, wherein the at least one solid portion of the common electrode and/or the first substrate are configured to accommodate the corresponding one of the spacers.

8. The liquid crystal display device as recited in claim 6, further comprising at least one common line formed on the second substrate, wherein the at least one solid portion of the common electrode electrically connects with the at least one common line respectively.

9. The liquid crystal display device as recited in claim 1, wherein each of the openings defines a rectangular shape when considered from a top aspect thereof.

10. The liquid crystal display device as recited in claim 1, wherein the openings are holes.

11. The liquid crystal display device as recited in claim 1, wherein the openings are blind slots.

12. The liquid crystal display device as recited in claim 1, wherein the openings are through slots.

13. A liquid crystal display device, comprising:
a first base plate comprising a first substrate and a common electrode formed at the first substrate, the common electrode comprising a plurality of portions with spaces therebetween;
a second base plate opposite to the first base plate, the second base plate comprising a second substrate and a plurality of gate lines formed at the second substrate and positionally corresponding the spaces of the first base plate respectively; and
a liquid crystal layer sandwiched between the first and the second base plates.

14. The liquid crystal display device as recited in claim 14, wherein a width of each of the gate lines is equal to or less than a corresponding width of each of the spaces of the first base plate.

15. The liquid crystal display device as recited in claim 14, wherein at least one of gate lines underlies one or more of the spaces of the sfirst base plate.

16. The liquid crystal display device as recited in claim 14, wherein the spaces are blind slots.

17. The liquid crystal display device as recited in claim 14, wherein the spaces are through slots.
